(19) United States
(12) Patent Application Publication
(10) Pub. No.: US 2026/0111820 A1
(43) Pub. Date: Apr. 23, 2026

(54) System

(71) Applicant: Softbank Group Corp., Tokyo (JP)

(72) Inventor: Hiroyuki Irie, Tokyo (JP)

(21) Appl. No.: 19/360,661

(22) Filed: Oct. 16, 2025

(30) Foreign Application Priority Data
Oct. 18, 2024 (JP) 2024-183877

(51) Int. Cl. G06Q 10/0633

(52) U.S. Cl. CPC G06Q 10/06332

(57) ABSTRACT

A system includes a processor that is configured to acquire a video of a business procedure using an image capturing device, collect audio data and text data, analyze the collected data to generate a business procedure model, generate an automation program based on the business procedure model, and distribute the generated automation program to a terminal.

### CROSS-REFERENCE TO RELATED APPLICATION

This application is based on and claims priority under 35 USC 119 from Japanese Patent Application No. 2024-183877 filed on October 18, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In many business environments, the automation of tasks is hindered by the requirement for specialized programming knowledge and complex system configurations. Conventional robotic process automation (RPA) solutions often require users to manually program automated workflows or use complicated user interfaces, limiting accessibility for non-technical users. Furthermore, conventional systems may not effectively convert actual business procedures, as demonstrated by users, into reliable automated processes, resulting in inefficiencies, increased labor costs, and reduced productivity.

### SUMMARY

The present invention provides a system comprising a processor configured to acquire video of a business procedure using an image capturing device, collect audio data and text data, analyze the collected data to generate a business procedure model, generate an automation program based on the model, and distribute the program to a terminal. The processor recognizes business operations from the video data and obtains analysis results accordingly. Furthermore, the processor converts audio data to text and extracts business instruction content using natural language processing technology. By these means, the system enables users, regardless of programming skill, to easily automate and execute business workflows based on procedures they demonstrate and explain, thus improving efficiency and reducing errors.

“Image capturing device” means a device capable of recording visual information, such as a camera, smartphone, or any apparatus capable of acquiring video data.

“Audio data” means information representing sound, such as speech or environmental noise, collected during the acquisition of the business procedure.

“Text data” means information represented by alphanumeric characters, including memos, notes, instructions, or any descriptive text input by the user regarding the business procedure.

“Processor” means a hardware component, such as a central processing unit or microprocessor, configured to execute programmed instructions for controlling and processing system operations.

“Business procedure model” means a structured representation of a series of actions, steps, or workflows as performed in the business process, generated by analyzing collected data.

“Automation program” means a set of instructions or script that, when executed by a computer or terminal, automatically carries out some or all of the steps of the business procedure without human intervention.

“Terminal” means an electronic device, such as a computer, tablet, or smartphone, which can receive, store, and execute the automation program.

“Natural language processing technology” means computer-based techniques and algorithms designed to process, analyze, and understand human language input in audio or text form, and to extract relevant information or instructions.

“Distribution” means transmitting, sending, or making available the generated automation program from the processor to at least one terminal for execution.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

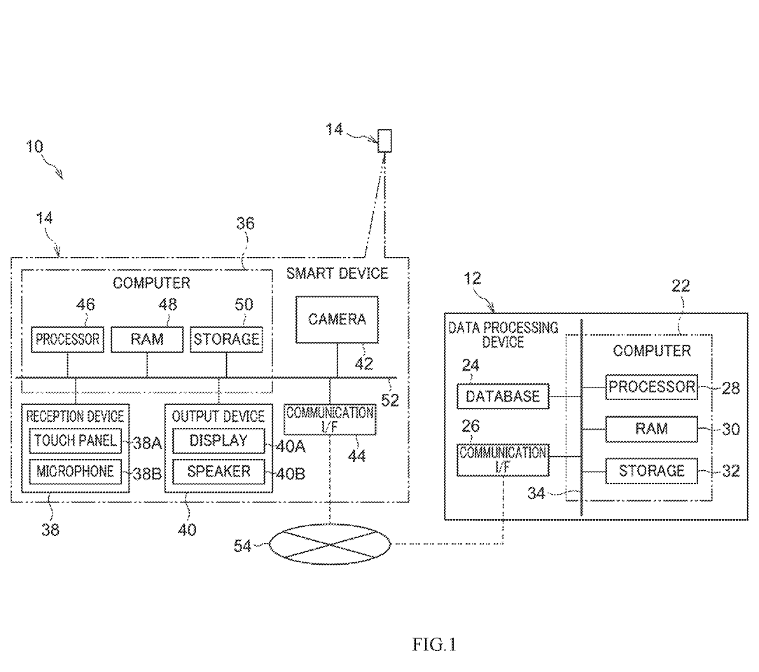

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

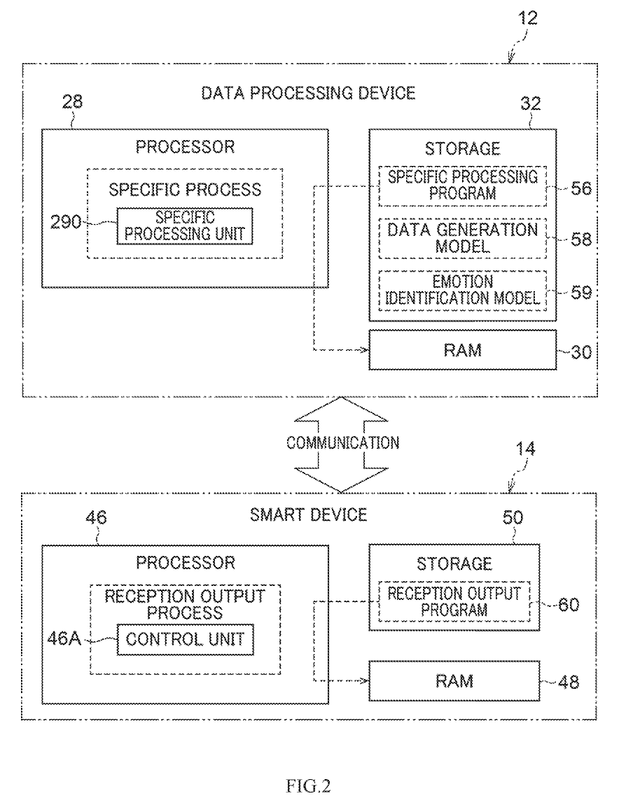

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In the field of business process automation, it is difficult for users without specialized programming skills to efficiently automate their own work procedures. Conventional systems face challenges in consistently integrating various types of information such as video, audio, and text, and accurately generating business commands, resulting in delays in creating automation programs necessary for business efficiency and productivity improvements.

The specific processing by the specific processing unit 290 of the data processing device 12 in Example 1 is realized by the following means.

The present invention provides a server comprising a processor configured to acquire business operation actions as video information, collect and store audio and character information, transmit the collected information from a terminal to a data processing unit, process and analyze the information using image processing, speech recognition, natural language processing, and a generative artificial intelligence model, generate a business procedure model and an automation program accordingly, and distribute the program to the terminal for execution. This enables users to automatically generate business automation programs by simply recording their work procedures, without the need for specialized programming knowledge, through seamless integration and analysis of multimodal information.

The term “information acquisition apparatus” refers to an apparatus configured to capture information related to business operations, including but not limited to video cameras, imaging devices, or any device capable of recording visual data.

The term “terminal apparatus” refers to an electronic device, such as a mobile terminal, smartphone, tablet computer, or dedicated computing terminal, that is capable of storing, managing, and transmitting collected information.

The term “data processing apparatus” refers to a computing system, such as a server or cloud-based computer, equipped with the capability to receive, process, and analyze multiple types of data, including video, audio, and text.

The term “image processing technology” refers to any method or software algorithm capable of analyzing and interpreting video or image data to detect or recognize actions and subjects, such as computer vision techniques.

The term “speech recognition technology” refers to methods or software for converting spoken language or audio data into text data.

The term “natural language processing technology” refers to methods, models, or algorithms for analyzing, interpreting, and extracting meaning from human language data, typically using computational linguistics or artificial intelligence.

The term “generative artificial intelligence model” refers to a machine learning model, such as a large language model, capable of generating outputs or extracting information based on multi-modal data by learning from large datasets.

The term “business command” refers to an instruction or directive extracted from collected data that describes a specific task, action, or operation to be automated within a business process.

The term “business parameter” refers to contextual information associated with a business command, including data values, identifiers, quantities, or conditions relevant to executing an automated procedure.

The term “business procedure model” refers to a structured representation of a sequential set of business actions, steps, or tasks derived from processed information and designed to reflect actual business operations.

The term “program generation apparatus” refers to a computational resource or software tool for automatically generating executable automation programs or scripts based on a given business procedure model.

The term “business automation program” refers to a computer-executable script or application that performs specified business tasks automatically according to the defined business procedure model.

The term “computer vision technology” refers to methods and tools that enable a computer system to interpret and analyze visual information from images or videos.

The term “action recognition processing” refers to the technique or process of identifying specific actions or activities within visual or audiovisual data by analyzing patterns, gestures, or movements.

The term “procedure information” refers to details describing the sequence, content, and specific operations comprising a business process, extracted from various data inputs.

An embodiment for implementing the invention will now be described.

The system according to the present invention includes an information acquisition apparatus, a terminal apparatus, a data processing apparatus (such as a server), communication means, and software resources for multimedia analysis and automatic program generation.

The user utilizes the information acquisition apparatus, such as a digital camera or a camera-equipped mobile terminal, to record specific business procedures in the form of video data. The user also provides spoken explanations during the recording, which are captured as audio data. The terminal apparatus, which may be a smartphone, tablet, or dedicated terminal device, stores the video and audio data and subsequently transmits these files to a data processing apparatus using wireless communication (for example, via Wi-Fi or mobile data network).

The server receives the video and audio files. The server is equipped with software for image processing, such as general-purpose frameworks for computer vision (for example, “OpenCV” or “TensorFlow”), which allows the server to analyze video data frame by frame and detect relevant actions being performed, such as picking up objects or entering information. For analysis of the audio data, the server implements speech recognition technology (such as “SpeechRecognition” or “wav2vec 2.0”), converting spoken content to text format.

After the conversion, the server applies natural language processing technology, such as a generative AI model (for example, a large language model or open-source transformer-based model), to extract business commands, parameters, and detailed instructions from the textual data. This extracted information is used in conjunction with the recognized action data to automatically build a business procedure model, reflecting the workflow carried out by the user.

With this business procedure model, the server then utilizes a program generation apparatus, which may rely on automation scripting frameworks (for example, “UiPath,” “Automation Anywhere,” or Python-based frameworks using the “openpyxl” library), to automatically produce a business automation program. This program is designed to automate the recognized workflow. For instance, it can generate a script that automatically enters product IDs and quantities into a spreadsheet application such as Excel.

Once generated, the business automation program is distributed from the server to the user’s terminal apparatus. The terminal stores this program and, upon the user’s instruction, executes the automation, allowing the user to perform standardized business procedures efficiently and with minimal manual data entry.

By integrating video, audio, and text data, the system permits even non-technical users to create sophisticated business automation programs simply by demonstrating and explaining their business procedures.

As a concrete example, consider a user in a warehouse who wants to automate the inventory input process. The user records a video while narrating, “I am placing product B with barcode 789456 into section 8. There are ten units in total.” The terminal transmits these data. The server analyzes the video and audio, recognizes the actions and instructions, and generates an automation script that fills in the relevant fields in an inventory management spreadsheet with the described information. The automation program is then delivered to the user’s terminal, where it can be executed as needed.

An example prompt sentence usable with the generative AI model is as follows:

“Please analyze this transcript and video segment to extract stepwise business actions and generate an RPA script that replicates the recognized workflow in Excel.”

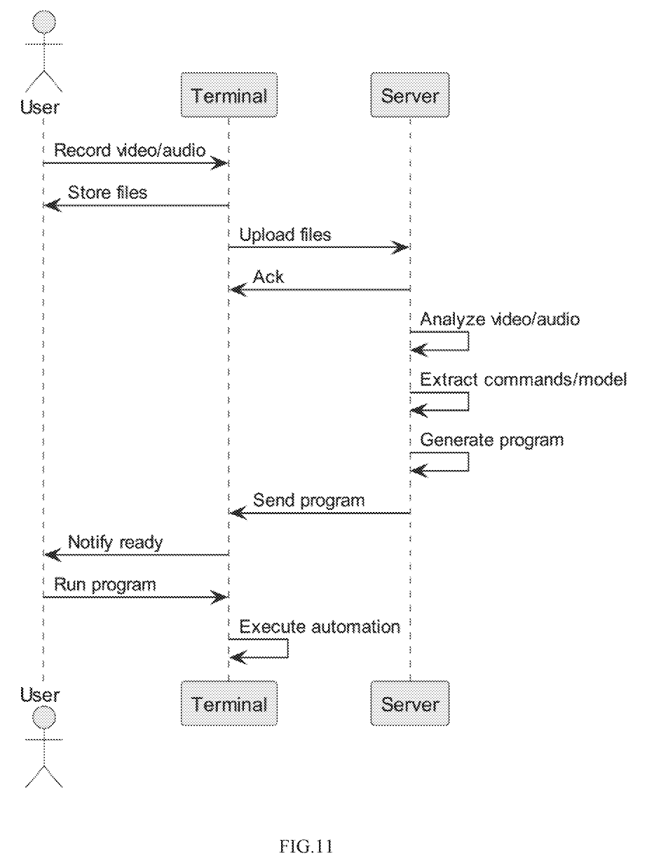

The following describes the processing flow using FIG. 11.

### Step 1:

User uses the terminal to begin recording a business procedure. The user positions the terminal, such as a smartphone, to capture the workspace, and starts video recording while performing the actual task, for example placing a product on a shelf or scanning a barcode. At the same time, the user provides a spoken explanation, such as stating the product ID and quantity. The input for this step is the real-world business activity and narrative, and the output is video and audio data files recorded and saved on the terminal.

### Step 2:

Terminal stores the recorded video and audio data locally and prepares them for upload. The terminal performs a check for file integrity and organizes the files for transfer. The input is the recorded media files, and the output is a set of validated and structured files ready to be uploaded to the server.

### Step 3:

Terminal transmits the video and audio files to the server using a secure wireless connection, such as Wi-Fi or mobile data. The terminal sends the files via a designated upload API. The input is the validated media files on the terminal, and the output is data packets sent to the server.

### Step 4:

Server receives and stores the uploaded video and audio files. The server confirms successful transfer and saves the data in an organized storage location, associating it with a suitable business process ID. The input is the data packets from the terminal, and the output is structured storage of video and audio files on the server.

### Step 5:

Server analyzes the video data using image processing and computer vision techniques. The server extracts video frames, detects movements, and identifies specific business actions, such as “scanning barcode” or “placing product.” The input is the video data file, and the output is a sequence of action recognition results and associated time indexes.

### Step 6:

Server transcribes the audio data into text using speech recognition technology. The server processes the audio stream and produces a text transcript of the user's narration. The input is the audio file, and the output is a text file containing the recognized speech.

### Step 7:

Server applies natural language processing and a generative AI model to the transcript. The server analyzes the text to extract business commands, parameters, and contextual information, such as product IDs and quantities, and links these elements to detected actions in the video analysis. The input is the text transcript and action recognition results, and the output is structured business instructions enriched with parameter values.

### Step 8:

Server combines the recognized actions and extracted instructions to generate a business procedure model. The server organizes process steps, aligns actions with commands, and creates a representation (for example, as a structured data model) describing the entire business workflow. The input is the annotated instructions and recognized actions, and the output is a business procedure model.

### Step 9:

Server uses a program generation module to automatically create a business automation program based on the procedure model. The server maps each step in the workflow to automation logic (for example, Excel input or barcode registration code), generating a script or executable file that automates the process. The input is the business procedure model, and the output is a business automation program.

### Step 10:

Server distributes the generated automation program to the terminal via a download or push notification. The terminal receives the program and makes it available for user execution. The input is the automation program on the server, and the output is the stored executable program on the terminal.

### Step 11:

User executes the received automation program on the terminal. The user selects and runs the program, which performs the business process automatically, for example, filling in an inventory sheet based on the earlier recognized information. The input is the automated program and the user's command to run it, and the output is the completion of automated business operations on the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional work environments, it is difficult for workers without programming skills to automate and visualize work procedures efficiently and accurately. Manual processes are prone to errors and inefficiencies, hindering productivity improvements. Moreover, current systems do not effectively integrate multimodal data such as images, audio, and text, nor do they dynamically adapt support based on user conditions or emotional states, leading to poor adaptability and suboptimal guidance for users.

The specific processing by the specific processing unit 290 of the data processing device 12 in Application Example 1 is realized by the following means.

The present invention provides a server comprising a processor configured to acquire work procedure information using an image acquisition device, collect acoustic and character information, analyze multimodal data to generate an operation procedure model, generate an automated processing program based on the model, deliver the program to an information terminal device, and dynamically change the displayed content based on user status recognition information. This enables seamless visualization and automation of complex work procedures, minimizes errors, and provides adaptive support tailored to user conditions and emotional states for improved operational efficiency and user experience.

The term “image acquisition device” refers to a hardware apparatus capable of capturing visual information, such as a camera or smart glasses, used for recording work procedures in real time.

The term “acoustic information” refers to audio data obtained during work procedures, including spoken instructions, environmental sounds, or any voice communication relevant to the operational process.

The term “character information” refers to textual data related to work procedures, including manually input notes, instructions, warnings, or information derived from converting speech to text.

The term “operation procedure model” refers to a structured representation of steps, actions, and instructions that compose a specific work process, generated by analyzing visual, audio, and textual data.

The term “automated processing procedure program” refers to a set of executable instructions generated to automate the execution of operation procedures, created based on the operation procedure model.

The term “information terminal device” refers to an electronic device used by the user, such as a smart glasses display, smartphone, tablet, or personal computer, which receives and executes the automated processing procedure program.

The term “presentation device” refers to output hardware, including displays integrated in smart wearables or external monitors, used to present visual or auditory guidance, instructions, or support to the user based on the work procedure.

The term “user status recognition information” refers to data indicating the physical or emotional state of the user, derived from analyzing facial expressions, voice patterns, or physiological measurements to adapt system outputs and support.

The term “automated knowledge processing device” refers to a computational mechanism, including artificial intelligence models or software engines, that generates an automated processing procedure program by utilizing the operation procedure model and associated generation instruction information.

The term “generation instruction information” refers to data that specifies parameters, conditions, or requirements for generating an automated processing procedure program based on the operation procedure model.

One embodiment for implementing the invention is described as follows:

The system comprises a server, a user terminal, and at least one image acquisition device. The user attaches the image acquisition device, such as a wearable smart glasses or a camera-equipped mobile device, to record a work procedure in a workplace environment. The user terminal, which may include a smartphone, tablet, or dedicated wearable device, collects acoustic information through a microphone and character information through manual entry or automatic transcription of speech.

The terminal sends the collected image, acoustic, and character information via a secure network connection to the server. The server executes a series of data processing tasks utilizing hardware with sufficient computational capacity, such as a cloud computing server or high-performance workstation, and software resources including image recognition libraries (for example, general-purpose computer vision APIs), speech-to-text engines, and natural language processing tools.

The server analyzes the uploaded image data using computer vision technology to extract and label user actions and environmental features relevant to the work procedure. For processing acoustic information, a speech-to-text engine is employed to transcribe voice inputs. The resulting character information is further processed by a natural language processing engine to extract operational instructions or warnings.

The server then synthesizes the extracted actions, instructions, and manually entered text into an operation procedure model, a structured data representation of the work process. Using an automated knowledge processing device, which may be implemented as a generative AI model or an algorithmic workflow generator, the server creates an automated processing procedure program. This program is tailored to the operation procedure model and may embed adaptive instructions or support mechanisms that respond to user status recognition information, such as indications of user stress, confusion, or other emotional states.

The generated automated processing procedure program is transmitted from the server to the user’s information terminal. The terminal presents the instructions and support content to the user by means of a presentation device, which can be a display on smart glasses or a mobile device screen. This presentation device dynamically adapts instructions and guidance according to the latest user status recognition information, enhancing usability and effectiveness.

A practical example involves a user at a distribution center who wears smart glasses while picking items from shelves. The system records the user's movements and speech, processes the data on the server, recognizes the sequence of operations, and generates a workflow. If emotion estimation reveals that the user is stressed during a particular task, the presentation device may offer visual cues, play safety reminders, or suggest a short break. This guidance is automatically adjusted and delivered to the user for optimal operational support.

An example of a prompt sentence for the generative AI model is:

"Develop an application that records a worker's picking process via smart glasses (including both video and audio), analyzes the data to extract workflow steps and user emotions, and generates an automated program that provides tailored visual instructions on wearable devices and automates related data entry tasks."

In this way, the invention provides a comprehensive solution for automated extraction, modeling, and delivery of operational workflows, incorporating multimodal data processing, generative program synthesis, and adaptive user support. The system is suitable for deployment in a variety of professional settings requiring efficient process automation and robust human-machine interaction.

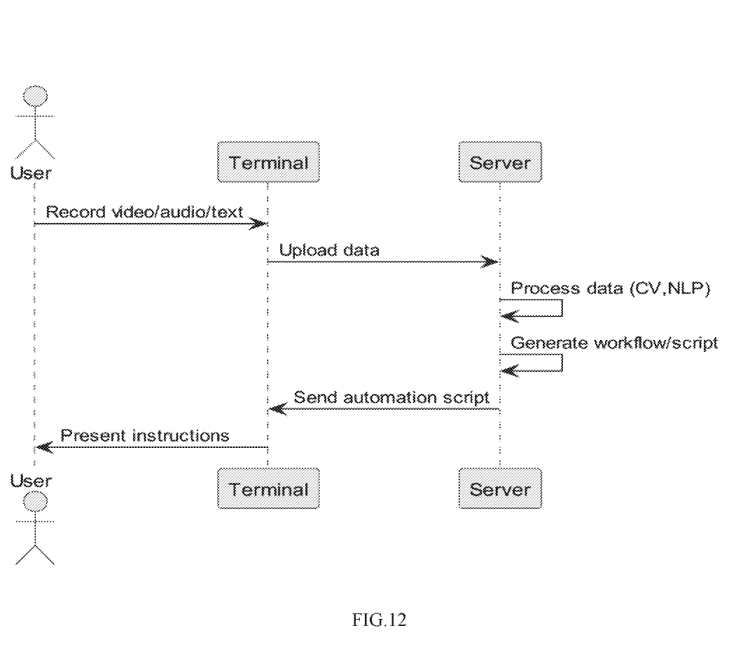

The following describes the processing flow using FIG. 12.

### Step 1:

User attaches an image acquisition device, such as smart glasses or a wearable camera, and begins performing the actual work procedure.

Input: Work environment, physical user actions.

Output: Recorded video data of user’s point of view and physical activities.

User also speaks aloud any instructions, warnings, or comments; in addition, user may manually enter important notes using a mobile terminal.

Input: Voice instructions, manual text input.

Output: Recorded audio data and character information.

### Step 2:

Terminal collects and stores video data, audio data, and any text data generated by the user.

Input: Video files, audio files, and text files from the user’s activities.

Terminal adds relevant metadata (timestamp, location, user ID) to each data file.

Output: Packaged multimedia data with associated metadata.

### Step 3:

Terminal transmits the collected multimedia and metadata to the server over a secure communications network.

Input: Video, audio, text files with metadata.

Terminal authenticates the connection and uploads data to cloud storage associated with the server.

Output: Uploaded multimedia files and metadata available on server storage.

### Step 4:

Server processes the uploaded video data using a computer vision engine.

Input: Video files from the terminal.

Server performs frame-by-frame analysis to detect user actions, objects, and relevant workflow steps using image recognition algorithms.

Output: Segmented and labeled actions with time indices (e.g., “pick item,” “scan barcode”).

### Step 5:

Server processes the uploaded audio data using a speech-to-text engine.

Input: Audio files from the terminal.

Server converts spoken instructions and comments into text transcripts.

Output: Transcribed text containing operational instructions and warnings.

### Step 6:

Server analyzes all character information, including transcribed text and manual notes, using a natural language processing engine.

Input: Text files (manual and transcribed).

Server extracts specific work instructions, warnings, or important workflow information through context-aware language analysis.

Output: Structured list of operational instructions and contextual tags.

### Step 7:

Server optionally analyzes user status (emotional and physical state) based on video and audio data.

Input: Video and audio files.

Server utilizes emotion recognition software to estimate user stress, confusion, or satisfaction during each workflow segment.

Output: User status recognition information associated with each workflow segment.

### Step 8:

Server generates an operation procedure model by integrating segmented actions, extracted instructions, manual notes, and user status information into a structured process map.

Input: Labeled actions, structured instructions, user status data.

Server organizes all elements into a data model representing the sequence and logic of the work procedure.

Output: Operation procedure model in a format such as JSON or a directed graph.

### Step 9:

Server generates an automated processing procedure program using an automated knowledge processing device, such as a generative AI model or a workflow scripting engine.

Input: Operation procedure model and associated instruction data.

Server synthesizes context-appropriate workflow automation logic, optionally customizing content based on user status recognition (e.g., including extra support in response to detected stress).

Output: Automated processing procedure program (e.g., RPA workflow script).

### Step 10:

Server delivers the generated automated program to the information terminal device.

Input: Automated processing procedure program.

Output: Program transmitted to and installed on the user’s terminal.

### Step 11:

Terminal presents the automated workflow and guidance instructions to the user via the presentation device, such as a smart glasses display or a tablet screen.

Input: Automated program, operation procedure model, user status data.

Terminal dynamically updates displayed instructions and support content as the user proceeds through the work steps, using AR overlays, visual cues, or auditory prompts.

Output: Stepwise, adaptive operational support for the user to perform or automate the work procedure efficiently.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional task automation systems, support tailored to an individual’s emotional state is insufficient, often leading to increased stress and anxiety for users during task execution. Existing technologies primarily focus on improving task workflow efficiency, but do not adequately address the quality of the user experience, particularly in terms of emotional well-being. As a result, there is a risk that user satisfaction and overall system effectiveness may be compromised. Therefore, there remains a need for a technology that can both enhance operational efficiency and provide adaptive support based on the emotional condition of each user.

The specific processing by the specific processing unit 290 of the data processing device 12 in Example 2 is realized by the following means.

The present invention provides a server comprising a processor configured to capture images of task processes, collect acoustic and document information, analyze the collected information to generate a task process structure, estimate the emotional states of users from facial expressions and voice tone, generate process automation information based on the task process structure, customize the automation information in accordance with the estimated emotional states, and transmit the customized process automation information to a terminal. This enables both the optimization of task procedures and the delivery of individualized, emotion-adaptive support, thereby improving both operational efficiency and the quality of the user experience.

The term “image acquisition device” refers to a hardware apparatus capable of capturing visual information in the form of still images or video footage of task processes.

The term “acoustic information” refers to data representing audio signals, including spoken instructions, verbal interactions, or other sounds captured during the execution of a task process.

The term “document information” refers to textual data that may be derived from transcribed audio, pre-existing written instructions, or any other format containing alphanumeric characters relevant to the task process.

The term “information analysis device” refers to a computing component or module configured to process and analyze collected image, audio, and text data in order to extract structured elements representing the steps of a task process.

The term “task process structure” refers to a data model or representation that depicts the sequence, relationships, and details of actions constituting a task process.

The term “information generation device” refers to a computing component or module configured to generate process automation information based on a task process structure.

The term “emotion estimation device” refers to a hardware or software module capable of determining the emotional state of a user by analyzing facial expressions and/or voice tone information.

The term “process automation information” refers to a set of data or instructions generated for automating or supporting the execution of a task process.

The term “information optimization unit” refers to a computing module configured to modify and customize process automation information in accordance with estimated emotional states of the user.

The term “information processing terminal” refers to an electronic device capable of receiving, storing, and executing process automation information as delivered from the server.

### Embodiment for Implementing the Invention

The invention can be embodied as a system consisting of several primary components, including a server, a terminal, and a user interface, configured to interact with one another to realize adaptive process automation based on user emotions.

The server comprises a processor and utilizes various software modules, such as image analysis libraries (for example, OpenCV or TensorFlow), audio analysis tools (such as Whisper ASR or a comparable speech-to-text engine), natural language processing libraries (such as spaCy or BERT), emotion estimation software (such as Affectiva SDK or a sentiment analysis API), and a generative AI model (such as GPT-4 or another large language model). These components may be implemented on general-purpose computing hardware, like rack-mounted servers or cloud-based virtual machines.

The terminal may be any information processing terminal, such as a workstation, laptop, tablet, or smartphone, which is equipped with an image acquisition device (e.g., an integrated or external camera) and a microphone. The terminal is configured to capture and locally store visual and acoustic information as the user performs task procedures. The terminal is also equipped with network client software to transmit collected information to the server via secure communication protocols (such as HTTPS).

The user interacts naturally with the work environment, performing ordinary operational tasks. The terminal unobtrusively records the user's activities using the camera and microphone. Audio from the microphone and video from the camera are stored as files on the terminal and then transmitted to the server.

The server receives and processes these files. The server’s image analysis component analyzes the visual data to detect and log specific actions performed by the user, such as picking up equipment or operating a console. The server’s audio processing component converts spoken words to text data and, using natural language processing, extracts commands, instructions, and relevant information that describe the task process.

The emotion estimation component of the server analyzes the user's facial expressions and the prosody of the user's voice during key moments in the task, estimating the user's emotional state (such as "neutral," "stressed," or "confident"). This information is combined with the extracted process structure.

The generative AI model on the server generates an automation script or workflow tailored to the user’s emotional states and the operational steps. For example, for steps identified as stress-inducing, the automation script might include additional explanatory pop-ups or supportive messages. The generated automation information is then transmitted back to the terminal, where it is executed through the terminal’s user interface.

As a concrete example, consider an operator in a call center environment. The user answers calls while being recorded by the terminal’s camera and microphone. The server analyzes the user’s stress levels during difficult customer interactions. For high-stress instances, the generative AI model creates automation scripts that display calming advice and quick access to resources at the appropriate steps. The user receives this guidance in real time, which improves both operational efficiency and user satisfaction.

The following are examples of prompt sentences that may be provided to the generative AI model to instruct it in generating adaptive automation scripts:

- "Analyze the following video and audio to extract work steps and infer emotional states, then generate an adaptive automation script."

- "For any step labeled 'stressed' or 'confused,' add additional instructions and links to resources in the automation program."

- "Create a step-by-step guide, enhancing support where the user shows signs of anxiety."

This embodiment enables the use of both existing hardware and general-purpose software frameworks to implement user-adaptive process automation thoughtfully guided by real-time emotion analysis and AI-driven content generation.

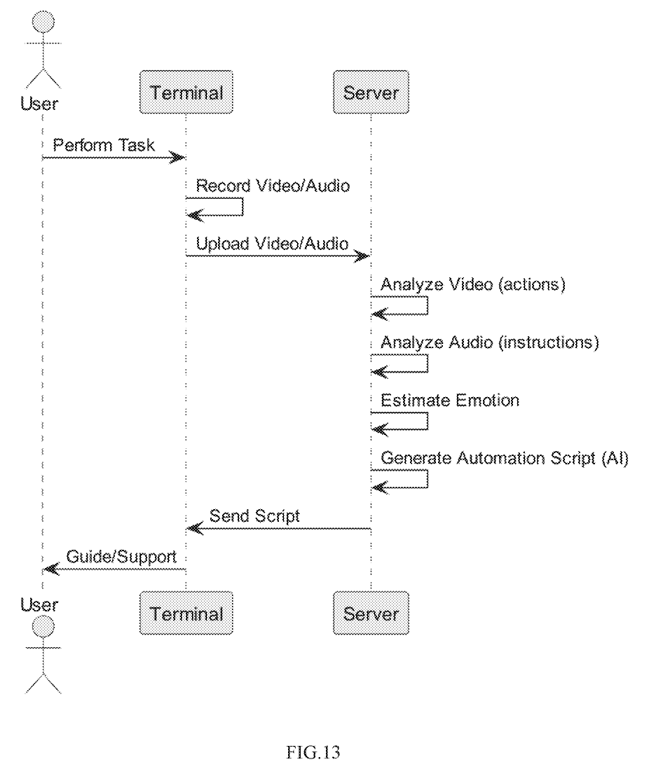

The following describes the processing flow using FIG. 13.

### Step 1:

User performs a series of operational tasks at the workplace in a natural manner, such as operating equipment, making phone calls, or following workflow instructions. Terminal uses its built-in or external camera to capture continuous video of the user's activities and uses its microphone to record audio. The input in this step is the real-time actions and speech of the user, and the output is stored video (e.g. MP4 format) and audio files (e.g. WAV format) on the terminal.

### Step 2:

Terminal establishes a secure network connection with the server, such as an HTTPS link, and uploads the recorded video and audio files to a predefined location on the server. The input in this step is the locally stored video and audio files; the output is the successful transmission of these files to the server’s storage system.

### Step 3:

Server executes an image analysis process using, for example, OpenCV or TensorFlow. Server processes the video file frame-by-frame to recognize user actions, such as picking up instruments, typing, or pressing buttons. The input is the video file sent from the terminal; the server applies image processing and object recognition algorithms to detect discrete actions. The output is a structured list or sequence of detected actions, each annotated with a timestamp.

### Step 4:

Server performs audio data processing by first converting speech into text using an automatic speech recognition engine such as Whisper ASR. Then, server uses a natural language processing tool like spaCy or BERT to analyze the transcribed text and extract work instructions, commands, or relevant procedural content. The input is the audio file received from the terminal; after ASR and NLP processing, the output is a time-labeled text data file containing identified instructions or commands.

### Step 5:

Server integrates the action sequence (from video) and the extracted instructions (from audio) to construct a task process structure using a process modeling framework or custom logic. The input is both the action list from step 3 and the instruction list from step 4; the server processes and merges this information to create a workflow or process model that represents the sequence of operational steps. The output is a digital representation of the full task process structure.

### Step 6:

Server estimates the emotional state of the user during each step by analyzing facial expressions from the video (using, for example, Affectiva SDK) and prosodic features from the audio (using a sentiment analysis API). The input is the original video and audio files, along with the task process structure. The server applies emotion recognition algorithms to detect states such as “neutral,” “stressed,” or “confident” for each process step. The output is a mapping of each step in the process structure to the corresponding estimated emotional state.

### Step 7:

Server sends the combined process structure and emotion mapping, as a prompt, to a generative AI model (for example, GPT-4 or a similar language model). Server constructs a prompt sentence based on the extracted information, such as “Generate an adaptive automation script that provides added guidance for steps where the user is detected as stressed.” The input is the process structure and emotion mapping; the generative AI model then processes the prompt and generates a custom automation script or workflow guide. The output is a text-based automation program, which includes tailored messages, extra explanations, or interactive support for emotionally challenging steps.

### Step 8:

Server transmits the generated automation script or guide to the terminal through a secure connection. Terminal receives and stores the script, then executes it by presenting the user with real-time step-by-step guidance, such as pop-up hints, calming messages, or interactive instructions, during the execution of their work procedure. The input to this step is the automation program generated by the server; the output is the active support and guidance delivered to the user at the terminal during their workflow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In manufacturing or factory environments, it is difficult to optimize both workflow procedures and the emotional state management of workers in an integrated manner. Conventional systems typically handle process optimization and worker wellbeing separately, resulting in inefficiencies, increased operational stress, and the lack of adaptive real-time support based on the worker’s condition. There is a need for a system that can simultaneously analyze workflow, monitor emotional states, and automatically provide adaptive support and improved instructions, thereby improving both productivity and worker comfort.

The specific processing by the specific processing unit 290 of the data processing device 12 in Application Example 2 is realized by the following means.

The present invention provides a server comprising a processor configured to record process steps using an image information acquisition device, collect audio information and character information, generate a process model based on the collected image information and audio information, estimate the emotional state of an operator from the image and audio information, generate an automatic control program and instruction format sentences based on the process model and the estimated emotional state, and distribute the generated automatic control program and instruction format sentences to an information processing terminal. This enables integrated optimization of both workflow procedures and worker emotional state management, and facilitates real-time, adaptive operational support for workers in industrial environments.

The term “image information acquisition device” refers to a hardware apparatus, such as a camera or video recorder, that captures visual data of a process or operation.

The term “audio information” refers to digital representations of sound, including speech, noises, or instructions occurring during the execution of a process.

The term “character information” refers to textual data that may be derived from audio information or manually input, representing instructions, annotations, or other relevant text information.

The term “analysis apparatus” refers to a computational unit or software functionality configured to process and analyze collected image and audio information in order to construct a process model.

The term “process model” refers to a structured representation of the procedural steps and workflow identified from the collected image and audio information.

The term “emotional state estimation apparatus” refers to a hardware and/or software module configured to detect and infer the emotional condition of an operator based on features extracted from image and audio information.

The term “automatic control program” refers to software code or scripts generated by the system to automate or guide processes in accordance with the process model and operator’s emotional state.

The term “instruction format sentences” refers to standardized sentences or prompts generated for the purpose of providing adaptive instructions or guidance to an operator.

The term “information processing terminal” refers to an electronic device, such as a tablet, smartphone, or computer, that receives and displays the generated automatic control program and instruction format sentences to the user.

One embodiment of the invention provides a system for optimizing workplace procedure and supporting operator wellbeing using automated workflow analysis and adaptive guidance.

The server comprises a processor and is configured to integrate data acquired from both an image information acquisition device and a terminal. The image information acquisition device may consist of a digital camera, industrial video recorder, or other video-capturing hardware capable of recording an operator’s activities. The terminal may be a portable tablet, a smartphone, or a dedicated industrial handheld device equipped with a microphone and a user interface for displaying guidance.

The user wears or operates the image information acquisition device to capture visual data of the work process onsite. Simultaneously, the terminal collects audio information such as spoken instructions and captures character information, such as annotations entered via touchscreen or keyboard.

The server receives the collected image and audio information transmitted securely by the terminal. The server employs software such as OpenCV for visual data processing to extract operational steps and construct a process model. For audio to text conversion, the server may use speech recognition services such as a cloud-based speech-to-text API. Additionally, the server utilizes natural language processing libraries, such as spaCy or NLTK, to analyze and extract instruction content from the transcribed character information.

To estimate the emotional state of the operator, the server uses a combination of facial expression analysis modules, such as an emotion recognition API, and paralinguistic analysis software, such as openSMILE, to process both image and audio data for emotional cues. Features like facial muscle movement, voice pitch, and speech tempo are analyzed to estimate indicators of fatigue, stress, or confusion.

The program generation apparatus on the server integrates the process model with the estimated emotional state. Utilizing a generative AI model, for example, a large language model like GPT or a similar framework, the server generates automatic control programs and adaptive instruction format sentences (prompt sentences). The instruction format sentences are tailored to the operator’s real-time state, providing actionable guidance, reminders, or automated simplifications to the workflow.

The server distributes the generated automatic control program and instruction format sentences to the terminal, which presents them to the user via visual display or audio output. The user can interact with the terminal to request clarifications, review detailed steps, or receive supportive prompts.

A specific example of a prompt sentence generated by the system is:

"Would you like to review the fuse alignment steps?"

### Another example is:

"Provide a simplified set of instructions for quality inspection on a conveyor belt, specifically targeted to reduce operator fatigue and confusion. Highlight 3 main steps and suggest ways to automate or provide visual support. Worker emotional state: fatigued."

Additionally, if the emotional analysis indicates operator stress during final inspection, a prompt may be:

"Would you like to pause for a short break or see tips for reducing errors during final inspection?"

Through the integration of these hardware and software components and the use of generative AI models for generating adaptive guidance, the system allows users to improve efficiency, reduce errors, and maintain operator wellbeing in complex work environments. This embodiment supports real-time, context-aware, and operator-sensitive automation and guidance.

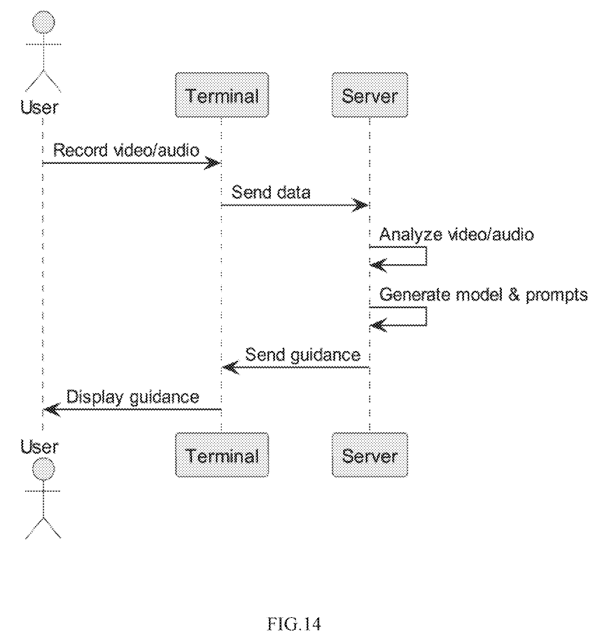

The following describes the processing flow using FIG. 14.

### Step 1:

The user operates an image information acquisition device, such as a digital camera or industrial video recorder, to record a visual log of their work process.

Input: The actual physical work process performed by the user.

Data processing: The camera or recorder captures video data of each step and action as the user performs tasks.

Output: High-definition video files that visually document the entire sequence of operations.

### Step 2:

The terminal, such as a tablet or handheld device, uses its built-in microphone to record audio data while the user performs tasks. The terminal also records any manually entered annotations as character information.

Input: Real-time ambient sounds, spoken instructions, and manual text inputs during task execution.

Data processing: The terminal digitizes the audio signal into files (such as WAV or MP3 format) and stores annotations as text data.

Output: Audio files and character information files linked by timestamp to the video data.

### Step 3:

The terminal securely transmits the recorded video files, audio files, and character information files to the server via a secure communication protocol, such as HTTPS.

Input: Video, audio, and character information files stored on the terminal.

Data processing: The terminal packages and encrypts the files, manages data transfer sessions, and confirms that uploads have succeeded.

Output: The server receives and stores the multi-modal data for analysis.

### Step 4:

The server analyzes the received video data using visual processing software, such as OpenCV, to extract distinct work steps from the visual stream.

Input: Video files from the image information acquisition device.

Data processing: The server applies object detection, motion tracking, and temporal segmentation to identify each precise operational step and composes a structured process model.

Output: A process model that catalogues work steps in chronological order.

### Step 5:

The server converts audio information into text using a speech recognition API. The server then applies natural language processing techniques to extract operational commands and instruction content from the transcribed text.

Input: Audio files recorded during task execution.

Data processing: The server sends the audio data to a speech-to-text recognition service, receives the converted text, and then refines the results with custom language parsing and annotation extraction.

Output: Character information files containing operational instructions and linked to corresponding steps in the process model.

### Step 6:

The server estimates the user’s emotional state by analyzing facial expressions from the video and vocal characteristics from the audio using emotion recognition modules.

Input: Synchronized video and audio information for each work step.

Data processing: The server identifies facial microexpressions, analyzes voice pitch and tone, and applies emotion inference algorithms to determine emotional states such as stress, fatigue, or confusion at each workflow stage.

Output: Emotional state labels mapped to each step in the process model.

### Step 7:

The server generates an automatic control program and instruction format sentences (prompt sentences) using a generative AI model, by combining the process model and emotional state data.

Input: The integrated process model and emotional state mapping.

Data processing: The server formulates input prompts for the generative AI model, which then produces optimized workflow instructions and adaptive guidance tailored to the user’s emotional condition.

Output: An automatic control program and prompt sentences ready to support and guide the user.

### Step 8:

The server transmits the generated automatic control program and prompt sentences to the terminal.

Input: Automatic control program and prompt sentences generated by the server.

Data processing: The server manages secure delivery and ensures the guidance is distributed to the appropriate terminal.

Output: The terminal receives actionable instructions and prompt sentences.

### Step 9:

The terminal presents the automatic control program and prompt sentences to the user via visual display or audio output, and receives feedback or interaction from the user as needed.

Input: Control program and prompt sentences delivered from the server.

Data processing: The terminal displays instructions visually, plays them as audio if enabled, and allows the user to interact through touch or voice input, such as requesting clarification or additional details.

Output: The user is provided with adaptive operational support and real-time guidance tailored to their current emotional state and workflow status.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

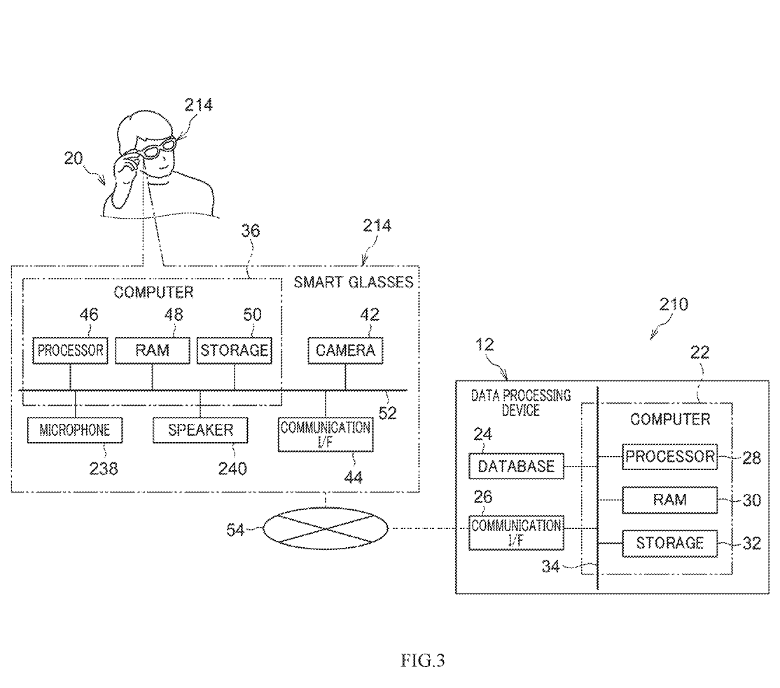

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

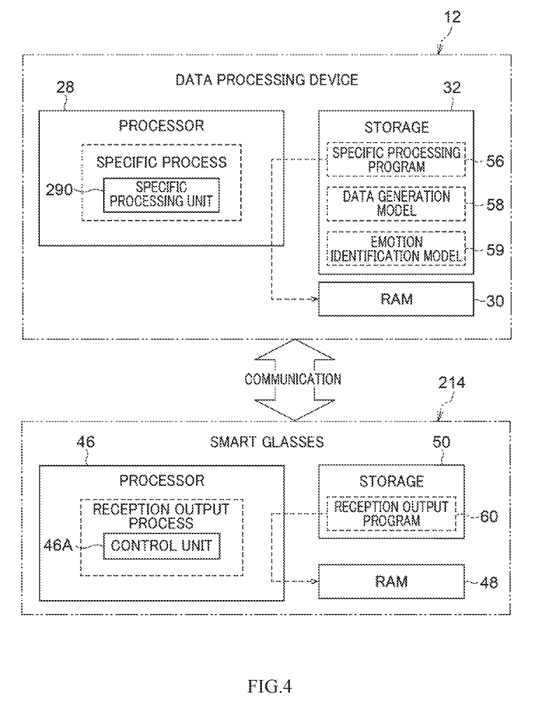

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

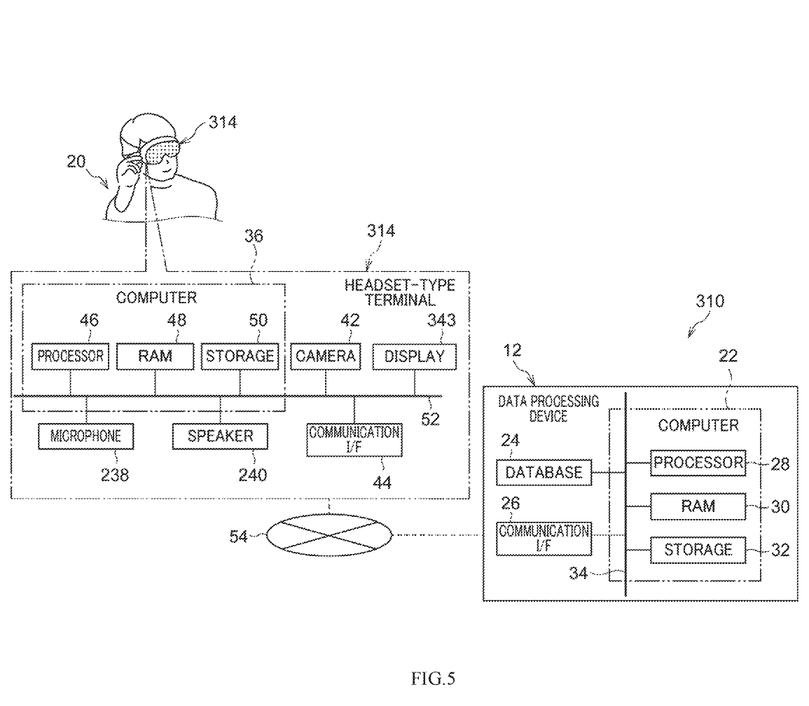

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

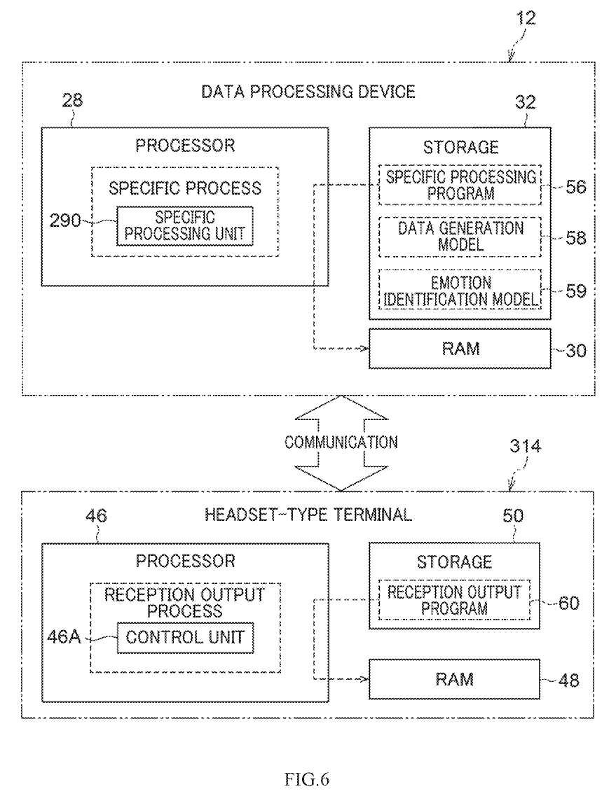

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

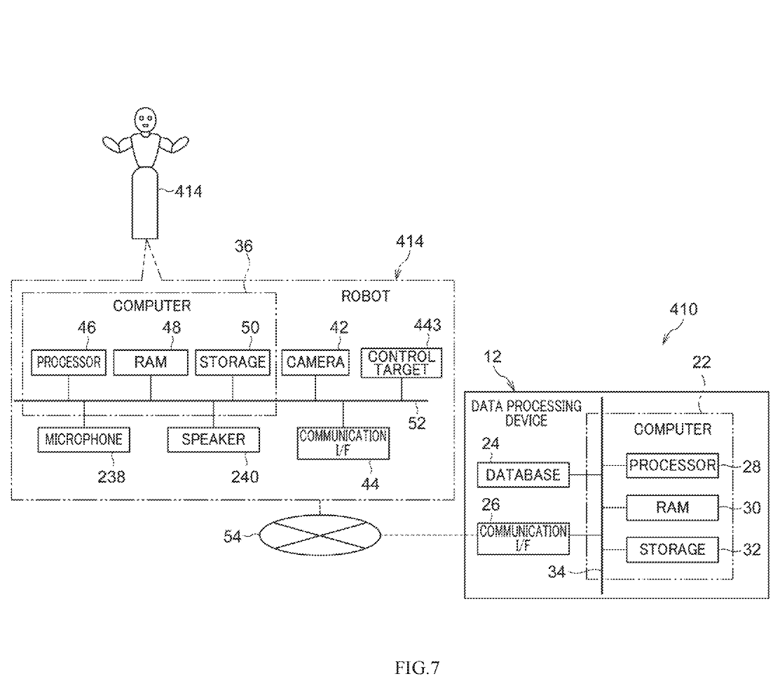

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

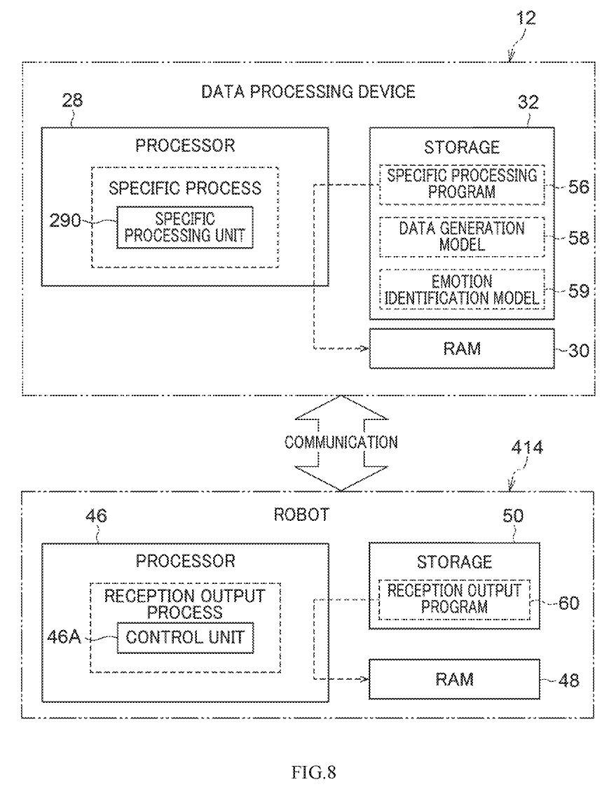

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

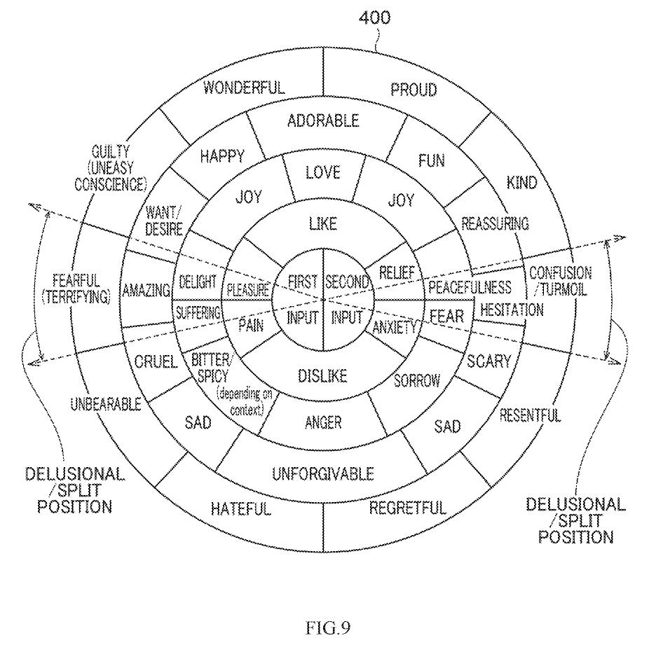

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o’clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don’t want to feel this way ever again” and “I don’t want to be chided again” is experienced in a robot. Another is a positive emotion in the area of “desire” on the reaction side. In other words, there are times when a positive feeling such as “desire more” and “want to know more” is experienced.

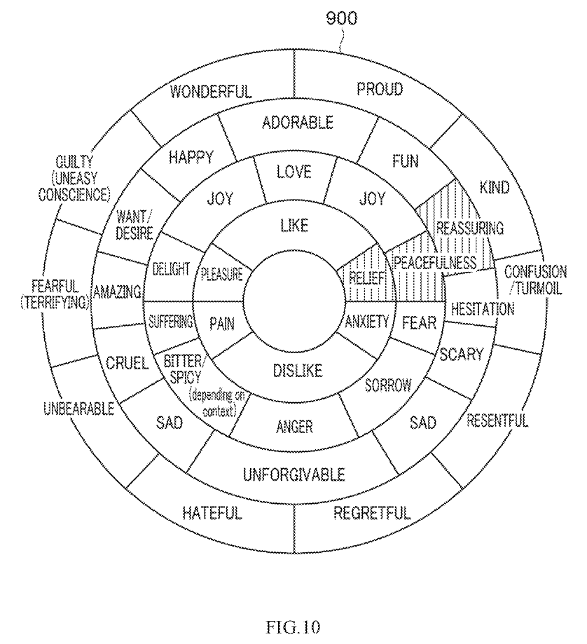

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,

wherein the processor is configured to

record operation-related actions of a business as video information using an information acquisition apparatus,

collect audio information and character information and store the collected information in a terminal apparatus,

transmit, via a communication apparatus, a plurality of types of collected information from the terminal apparatus to a data processing apparatus,

process the received video information with image processing technology, convert audio information into character information using speech recognition technology, and extract business commands and business parameters by using natural language processing technology and a generative artificial intelligence model,

generate a business procedure model based on the extracted business commands and business parameters, automatically generate a business automation program from the business procedure model using a program generation apparatus,

and distribute the automatically generated business automation program to the terminal apparatus to enable execution of the business automation program on the terminal apparatus.

### Supplementary 2

The system according to supplementary 1,

wherein the processor is configured to apply computer vision technology to the video information and identify action types and business objects in a business process through action recognition processing.

### Supplementary 3

The system according to supplementary 1,

wherein the processor is configured to convert audio information into character information through speech recognition processing and extract business commands, work parameters, and procedure information based on natural language processing technology and a generative artificial intelligence model.

### Application Example 1

### Supplementary 1

A system comprising a processor,

wherein the processor is configured to

obtain operation procedure information by recording work procedures using an image acquisition device,

collect acoustic information and character information,

analyze the image information, the acoustic information, and the character information to generate an operation procedure model,

generate an automated processing procedure program by an automated knowledge processing device based on the operation procedure model and generation instruction information,

provide the generated automated processing procedure program to an information terminal device, and

dynamically change display content of a presentation device according to the operation procedure model and user status recognition information.

### Supplementary 2

The system according to supplementary 1,

wherein the processor is configured to

extract actions in a work process from the image information using image recognition processing and generate the operation procedure model based on the identified actions.

(Supplementary 3)

The system according to supplementary 1,

wherein the processor is configured to

convert the acoustic information to character information, and automatically extract work instructions or warning content using natural language processing technology.

### Example 2

### Supplementary 1)

A system comprising a processor,

wherein the processor is configured to

capture task process images using an image acquisition device,

collect acoustic information and document information,

analyze the collected information and generate a task process structure using an information analysis device,

generate process automation information based on the task process structure using an information generation device,

estimate emotional states from facial expression information and voice tone information using an emotion estimation device,

customize the process automation information in accordance with the estimated emotional states using an information optimization unit,

and transmit the customized process automation information to an information processing terminal.

### Supplementary 2

The system according to supplementary 1,

wherein the processor is configured to

recognize actions in the task process from image information and acquire the recognition results using the information analysis device.

### Supplementary 3

The system according to supplementary 1,

wherein the processor is configured to

convert acoustic information into document information and extract instruction content using natural language processing technology.

### Application Example 2

### Supplementary 1

A system comprising a processor,

wherein the processor is configured to

record process steps using an image information acquisition device,

collect audio information and character information,

generate a process model based on the collected image information and audio information using an analysis apparatus,

estimate an emotional state of an operator from the image information and the audio information using an emotional state estimation apparatus,

generate an automatic control program and instruction format sentences based on the process model and the estimated emotional state using a program generation apparatus, and

distribute the generated automatic control program and instruction format sentences to an information processing terminal.

### Supplementary 2

The system according to supplementary 1,

wherein the processor is configured to

identify actions in the process from the image information and extract respective process steps in chronological order.

### Supplementary 3

The system according to supplementary 1,

wherein the processor is configured to

convert audio information into character information and extract process instruction content and emotional feature quantities using natural language processing technology.

What is claimed is:

1. A system comprising a processor,
wherein the processor is configured to acquire a video of a business procedure using an image capturing device,
collect audio data and text data,
analyze the collected data to generate a business procedure model,
generate an automation program based on the business procedure model, and
distribute the generated automation program to a terminal.

2. The system according to claim 1, wherein the processor is configured to recognize operations of the business procedure from the video data and obtain an analysis result based on the recognized operations.

3. The system according to claim 1, wherein the processor is configured to convert the audio data into text and extract business instruction content by using natural language processing technology.
